(19) United States
(12) Patent Application Publication
(10) Pub. No.: US 2011/0102201 A1
(43) Pub. Date: May 5, 2011

(54) METHOD AND SYSTEM FOR STABILIZING A VESSEL

(76) Inventor: Erik Jeroen Eenkhoorn, Hengelo OV (NL)

(21) Appl. No.: 12/921,125

(22) PCT Filed: Mar. 4, 2009
(86) PCT No.: PCT/NL2009/000052

§ 371 Date: Dec. 13, 2010

(30) Foreign Application Priority Data
Mar. 4, 2008 (NL) 1035148

(51) Int. Cl. G08B 23/00; B63B 43/12; A62C 3/10

(52) U.S. Cl. 340/984; 114/360

(57) ABSTRACT

The invention relates to a method for stabilizing and/or keeping afloat of a vessel after an incident like a marine accident, whereby by inflating at least one inflatable element in a subspace of the hold of the vessel by feeding inflating gas into the inflatable element, the inflatable element in its inflated use position is provided with such dimensions that essentially the free air of the subspace is displaced by the inflatable element so that flowing in of water into the hold of the vessel is hampered and/or spreading of fire is suppressed.

The invention relates to a method and system for stabilizing a vessel after an incident like a marine accident.

When a vessel becomes leaky, e.g. after an incident like a collision with another vessel or with a floating object like a buoy or a piece of wreckage, mostly a hole is ripped in the hull of the vessel, by which, depending on the size of the leakage or hole and its position above or below the waterline, water will enter into the hold of the vessel. As an effect of the leak water in the hold of the vessel—according to the law of Archimedes, the buoyancy of the vessel will decrease by the increased weight of the vessel or by the reduced amount of water displaced by the vessel hull. As a result of the reduction of the buoyancy (force) of the vessel, the vessel will be positioned deeper into the water, firstly with the hull. Due to this hydrostatics effect or the law of communicating vessels, an irreversible process is started moving the leakage or hole in the hull deeper into water, thereby causing more water to enter into the hold, resulting in a further reduction of the buoyancy of the vessel. As a result of the leakage in the hull, the vessel becomes unstable with regard to his buoyancy and dependent upon the size of the leakage, the vessel will unavoidably sink, when the average density of all the material of the vessel is higher than the density of the water.

Many solutions have been devised in order to prevent quickly sinking of a vessel with a leakage in the hull. A well known solution is to pump the leak water out of the hold of the vessel by means of a (bilge) pump. Sinking of the ship may be prevented when the delivery of the (bilge) pump is higher than the leak water flow rate. Another solution attempts to limit or stop the instability of the buoyancy of the vessel in case of a leakage by subdividing the hold into segments and liquid-tight closing the segment which comprises the hull part having the leakage, thereby interrupting the sinking process. Nowadays most vessels are provided with a (bilge) pump for removal of leak water from the hold; nevertheless the irreversible sinking process will resume when this pump fails e.g. by lack of fuel or by a mechanical failure and when in the meantime the hole in the hull is not plugged or closed.

In case of a breakout of a fire after a marine accident or another cause, it is essential to prevent a quick spreading of the fire. Because lower deck fire extinguishing is difficult and requires deployment and attention of persons it is expedient to prevent spreading of the fire to other subspaces of the hold, so that persons may accomplish their extinguishing activities without risking their lives.

Therefore there is a need for a system whereby quickly and reliably, at low costs, with a minimum chance of failure, a vessel may be stabilized after an incident like a leakage in the hull or a fire; whereby quickly sinking of the ship may be prevented and also spreading of a fire may be limited and valuable time may be gained e.g. in order to reach a harbour sailing and floating or to repair the leakage or to extinguish the fire while still floating on the water.

The object of the invention is therefore to provide a method and system whereby in case of a marine accident, like a sudden leakage in the hull or an onboard fire, the vessel may be stabilized by limiting the decrease of the buoyancy and to prevent spreading of the fire, furthermore the system must be low-cost, must allow for fast activation by non-specialists, and must be reliable during emergencies like onboard power supply or vessel motor failure thereby reducing the chance of accidents for onboard persons, fire extinguishers and maintenance personnel.

This object of the invention is achieved by inflating at least one inflatable element in a subspace of the hold of the vessel by feeding inflating gas into the inflatable element, so that the inflatable element in its inflated use position is provided with such dimensions that essentially the free air of the subspace is displaced by the inflatable element so that flowing in of water into the hold of the vessel is hampered and/or spreading of fire is suppressed.
The above mentioned features provide for an element filled with inflating gas in the hold of a ship, which prevents leak water flowing and entering further into the hold of the vessel and also prevents further spreading of the fire by removal of the free air from the subspace.

Alternative methods are described in claims 2-9. By these measures an improved performance is obtained or the reliability increased; the (horizontal) stability of the vessel is improved; simple and reliable means are provided; the risk on injuries for the persons onboard is decreased; displacement of the free air for suppressing spreading of a fire or for limiting the decrease of the buoyancy may be easily remotely activated.

The invention also relates to a system for limiting the decrease of the buoyancy of a vessel, as described in claims 10-17. These measures improve the performance and/or the reliability and prevent failure of the system in case of a leakage of one or more of the inflatable elements.

Moreover the invention relates to an inflatable element for use in the method or in the system according to the invention, like described in claims 18 and 19.
The invention also relates to a vessel provided with a system comprising an inflatable element according to the invention.

The invention is further explained by means of a drawing of an embodiment of the inflatable element, whereby features and other advantages will come forward.

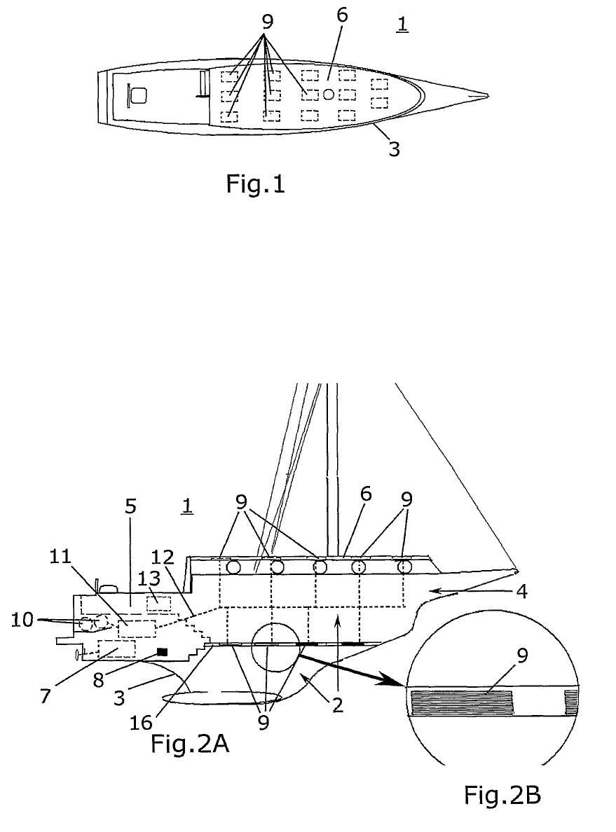

FIG. 1 shows in top view a vessel arranged for using the method according to the invention,

FIG. 2A shows in side view the vessel of FIG. 1,

FIG. 2B shows in detail an inflatable element for use in the method according to the invention,

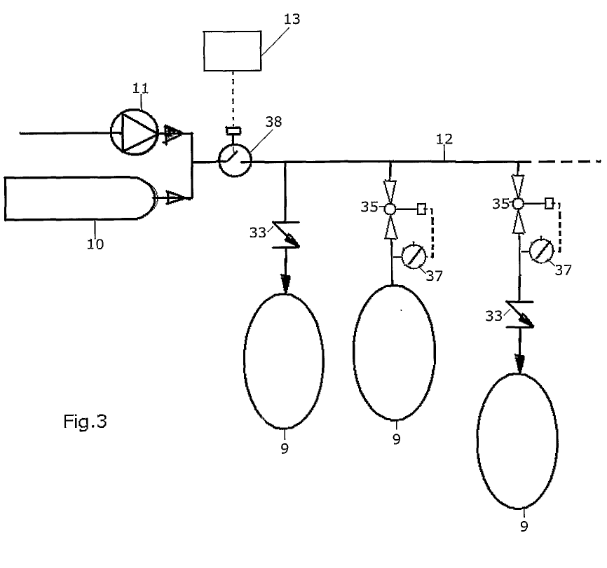

FIG. 3 shows schematically inflating means of the system for use in a vessel,

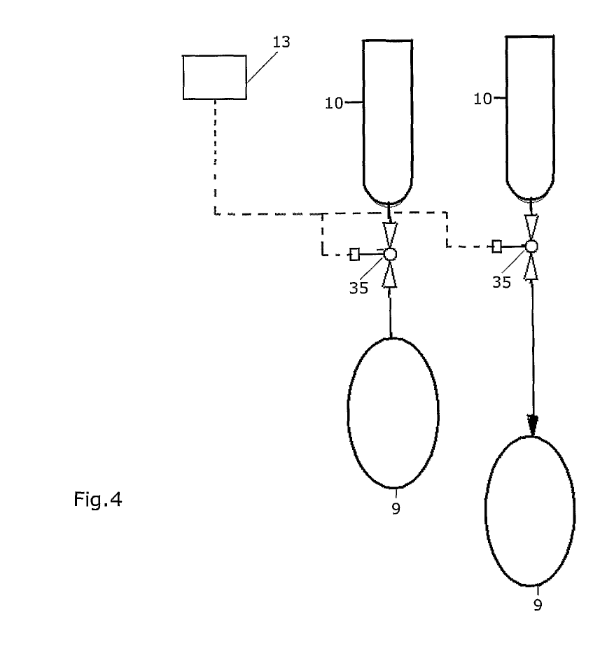

FIG. 4 shows schematically an alternative embodiment of the inflating means of the system.

FIG. 1 shows in top view a vessel 1 provided with inflatable elements 9 for stabilizing the vessel by displacing the free air for limiting the decrease of the buoyancy in case of a leakage in the vessel hull 3 and for preventing further spreading of a fire. In this embodiment a number of inflatable elements 9 or airbags are provided in the upper deck 6 of a sailing boat 1.
FIG. 2 shows in side view and schematically the vessel 1 of FIG. 1; the upper deck 6 and the lower deck 16 are provided with inflatable elements 9. In case of a hole or crack 8 in the hull 3 of the vessel 1 or a fire in the hold 2, the inflatable elements 9 are inflated by entering inflating gas into the inflating elements 9 such that the inflating elements 9 are folded open and occupy a large volume in the hold of the vessel 1 and thereby remove completely or to a great extend the free air. Because flowing in of water is hampered in a space occupied by the inflated inflatable element, the decrease of the buoyancy of the vessel by the entering water is limited or even stopped. The inflatable elements 9 are inflated by means of inflating means like a ring line 12 from gas reservoirs 10 or by means of a gas compressor or air pump 11 preferably being mounted in the proximity of the vessel motor and screw 7 and optionally coupled therewith and/or driven by it. In case of an lower deck fire and/or hole or crack 8 in the hull 3 nearby the machine room, there is a substantial chance of failure of the vessel motor 7 by the entering water or by the fire, causing the compressor or the pump not being able anymore to provide inflating air into the inflatable elements 9. Therefore preferably the system is configured by using a combination of a air compressor or pump 11 and gas reservoirs 10 such that in all circumstances the inflatable elements 9 may be inflated and sinking of the vessel 1 may be stopped. An advantageous choice for the system is a low pressure air pump 11, which combines a low discharge head with a high air delivery.
FIG. 3 shows in detail an inflatable element 9 mounted in the lower deck 16 of vessel 1. The inflatable element 9 may be inflated upwards into subspace 4 as well downwards into (keel) space 2.
Preferably the inflatable elements 9 are mounted and distributed over the hold 2 in such a way, that in case of a hole or crack 8 in the hull 3 the vessel 1 remains afloat in essentially horizontal position. When a vessel 1 starts listing or sinks with the bow or the stern into the water, water starts entering into the vessel through its upper side causing the vessel to be uncontrollable and rendering it unable to reach a safe harbour or a dry dock under its own power.
Preferably the system according to the invention is therefore provided with a control unit 13, whereby remotely, e.g. from the steering place 5 or the pilot house, the inflatable elements 9 may be provided with inflating gas by means of inflating means like gas reservoirs 10 and/or gas compressor 11 and/or ring line 12.

Preferably the inflatable elements 9 are pressurized up to pressure values ranging between 0.1 and 15 bar, but the invention is not limited to this range. In order not to injure, pinch or suffocate persons present in the subspace 4, in a first step the inflatable elements 9 in this spaces are inflated to a low pressure, so that persons, present in subspace 4, are offered the opportunity to evacuate the subspace 4 and bring themselves into safety. In this first phase optionally a acoustic/visual alarm system may be provided which is activated to warn onboard persons before, simultaneously with or directly after the activation of the inflating process. When all passengers and/or crew onboard of the vessel 1 are safe and have evacuated the hold 2, in a second step one or more inflatable elements 9 may be pressurized to a higher internal pressure e.g. by means of the aforementioned central control unit 13. Preferably a pressure is chosen which is 0.1 to 10 bar higher than the pressure of the first pressure step. As a result of the higher internal pressure in the inflatable element 9 the subspace 4 will be filled more completely and the inflatable element 9 will exert a higher counterpressure against the hydrostatic pressure of the water entered. The inflatable elements 9 are preferably mounted in a hold 2 or another closed space in order to prevent displacement and/or escape of the inflated element 9, thus preventing the loss of the preservation of the buoyancy.

Preferably the inflatable element is manufactured from a thin material, so that the elements in folded in position will occupy little space and moreover will be lightweight. Preferably the thickness of the material of the inflatable element is chosen from the range 10-1000 μm and more preferably is chosen from the range 20-100 μm. Furthermore persons present in the space wherein the inflatable element is inflated will not easily be pinched or get enclosed when thin material is applied.
By using thin material the chance of tearing of or getting leaks in the inflatable element increases e.g. caused by persons or objects present in the space.
Therefore in an preferred embodiment the inflatable element 9 is configured with two or more subelements and/or two or more compartments and for the material a base of polyurethane is chosen. By applying thin materials having a high polyurethane content, an advantageous inflatable element is obtained being lightweight and strong, being heat resistant and which may be stretched out considerably in conjunction with a high resistance against tearing. In a basic embodiment for one-time use the inflatable element 9 and its compartments are provided with non-return valves, so that after use the walls must be cut in order to be able to drain and to deflate the airbags and to remove them from the hold 2.

In FIG. 3 an embodiment is shown of inflating means of the system according to the invention. The system comprises at least two inflatable elements, which are interconnected to a ring line 12 by means of a non-return valve 33 or an open-close valve 35. This ring line is manually, e.g. by pressing an activation button 38 in the central control unit 13, provided with air and air pressure. Said air and pressure is provided by an air compressor or air pump 11 or by a high pressure storage vessel or gas reservoir 10, or a combination thereof. The activation button 38 may directly open the air supply to the ring line or may start the air compressor or the air pump 11. The non-return valve 33 prevents flowing out of air entered into the bag.
In an alternative embodiment an open-close valve 35 is provided which is normally opened and closes at failing pressure build-up in the inflatable element 9 due to leakage or closes at an excess high air flow e.g. caused by the readings of a failing measuring instrument 37 like a pressure sensor, flow sensor or by their combined readings. This measurement device 37 activates the open-close valve. The inflatable element 9 may also—in a second alternative embodiment—be connected with the ring line by means of a combination of a non-return valve 33 and an open-close valve 35 and a measurement device 37. Elements 33 and 35 mainly have the purpose to keep the system functional when one or more of the bags or elements 9 have a leak or become leaky during its use. The measurement and control devices 33, 35, 37 may be mounted locally, but may also be remotely controlled by the central control unit 13, e.g. for setting the setpoints of the pressure controllers 37 for the control loops consisting of a control valve 35 and a measurement device 37. The valves may be operated pneumatically or electronically.

In FIG. 4 is shown an alternative embodiment of the inflating means of the system according to the invention. The system comprises at least one or more inflatable elements 9 each being connected with a locally mounted high pressure storage vessel or gas reservoir 10 by means of an open-close valve 35. Inflating of the inflatable elements is activated, by means of an electronic signal, from the central control unit 13. As a result there is no need for non-return valves and the like.

1. A method for stabilizing a vessel after an incident, comprising:
inflating at least one inflatable element in a subspace (4) of a hold of the vessel by feeding inflating gas into the at least one inflatable element, so that the inflatable element in its inflated use position is provided with such dimensions that essentially free air of the subspace is displaced by the at least one inflatable element so that flowing in of water into the hold of the vessel is hampered and/or spreading of fire is suppressed.

2. The method for stabilizing a vessel according to claim 1, wherein the inflatable element comprises a thin material, so that the inflatable element in folded in position occupies a small volume and the inflatable element in its inflated use position may expand flexibly around objects located in the hold or a subspace thereof.

3. The method for stabilizing a vessel according to claim 2, wherein a thickness of the material of the inflatable element is chosen from the range 10-1000 μm.

4. The method for stabilizing a vessel according to claims 2, wherein the material of the inflatable element is a thin plastic having a polyurethane base.

5. The method for stabilizing a vessel according to claim 1, wherein two or more inflatable elements in the hold of the vessel are inflated, whereby the inflatable elements are distributed over the hold in such a way, that a vessel with a leak in its hull will stay afloat in an essentially horizontally position.

6. The method for stabilizing a vessel according to claim 1, wherein said inflating the inflatable element comprises at one least one selected from the group consisting of:
inflating the inflatable element with pressurized inflating gas in a gas reservoir;
inflating the inflatable element with inflating gas pressurized by a gas compressor;
inflating the inflatable element with gas provided from or airpump; and
a combination of the aforementioned.

7. The method for stabilizing a vessel according to claim 1, wherein the inflatable element in the inflated use position is provided with an excess pressure in the range between 0.01 and 0.5 bar.

8. The method for stabilizing a vessel according to claim 1, wherein the inflatable element in a first step is inflated into the use position with a first excess pressure having a range of 0-3 bar, subsequently in a second step the inflatable element is inflated into a higher pressure having an second excess pressure in the range of 0.1-10 bar added to the first excess pressure of the first step.

9. The method for stabilizing a vessel according to claim 8, wherein—before, simultaneously or after the first step—an acoustic and/or visual alarm is generated to warn the an onboard persons of the vessel.

10. A system for stabilizing a vessel after an incident, comprising at least one inflatable element in a subspace of a hold of a vessel, whereby the inflatable element is arranged to be brought into its inflated use position by feeding inflating gas into the inflatable element, the inflated element having such dimensions that essentially free air of the subspace is displaced by the inflatable element so that flowing in of water into the hold (2) of the vessel is hampered and/or spreading of fire on the vessel is suppressed.

11. The system for stabilizing a vessel according to claim 10, wherein the inflatable element comprises a thin material, so that the inflatable element in folded in position occupies a small volume and the inflatable element in its inflated use position may expand flexibly around objects located in the hold or a subspace thereof.

12. The system for stabilizing a vessel according to claim 11, wherein a thickness of the material of the inflatable element is chosen from the range 10-1000 μm.

13. The system for stabilizing a vessel according to claim 11, wherein the material of the inflatable element is a thin plastic having a polyurethane base.

14. The system for stabilizing a vessel according to claim 10, wherein the system comprises an inflating component, wherein said inflating component is selected from the group consisting of a ring line, one or more gas reservoirs, and one or more gas compressors of air pumps for feeding inflating air into the inflatable element.

15. The system for stabilizing a vessel according to claim 14, wherein the system further comprises a central control unit configured to remotely activate the inflatable elements by feeding inflating gas into the elements with one or more said inflating components.

16. The system for stabilizing a vessel according to claim 14, wherein one or more of the inflating components comprises a process control device for controlling and checking an inflating process.

17. The system according to claim 16, wherein the process control devices comprises one or more selected from the group consisting of:
a check valve;
a control valve with a measuring instrument, flow sensor or a combination thereof; and
a combination of a check valve and a control circuit.

18. An inflatable element for use in a system for stabilizing a vessel, wherein the inflatable element comprises a thin material, so that the inflatable element in folded in position occupies a small volume and the inflatable element in its inflated use position may expand flexibly around objects located in a hold (2) or a subspace of the vessel.

19. The inflatable element according to claim 18, wherein the inflatable element is configured by at least two sub-elements and/or comprises at least two compartments.

20. A vessel comprising a system according to claim 10.

21. The method for stabilizing a vessel according to claim 2, wherein a thickness of the material of the inflatable element is chosen from the range 20-100 μm.

22. The method for stabilizing a vessel according to claim 1, wherein the inflatable element in the inflated use position is provided with an excess pressure in the range between 0.02 and 0.2 bar.

23. The system for stabilizing a vessel according to claim 11, wherein a thickness of the material of the inflatable element is chosen from the range 20-100 μm.
